(19) United States
(12) Patent Application Publication
(10) Pub. No.: US 2014/0177136 A1
(43) Pub. Date: Jun. 26, 2014

(54) ACTIVATED CARBON, METHOD FOR PREPARING THE SAME, AND ELECTROCHEMICAL CAPACITOR INCLUDING THE SAME

(71) Applicant: SAMSUNG ELECTRO-MECHANICS CO., LTD., Suwon-si (KR)

(72) Inventors: Eun Sil Kim, Suwon-si (KR); Se Woong Paeng, Suwon-si (KR); Bae Kyun Kim, Suwon-si (KR); Jae Hoon Choi, Suwon-si (KR)

(73) Assignee: SAMSUNG ELECTRO-MECHANICS CO., LTD., Suwon-si (KR)

(21) Appl. No.: 14/106,204

(22) Filed: Dec. 13, 2013

(30) Foreign Application Priority Data
Dec. 14, 2012 (KR) 10-2012-0146427

(51) Int. Cl. H01G 11/34; C01B 31/12

(52) U.S. Cl. CPC H01G 11/34; C01B 31/12
USPC 361/502; 423/445 R; 423/460

(57) ABSTRACT

Disclosed herein are an activated carbon in which pores with pore sizes of 0.3˜5 nm account for 80% or higher based on an overall pore volume, a method for preparing the activated carbon, and an electrochemical capacitor including the activated carbon, so that, since the activated carbon has uniform sized fine pores, high-rate discharge characteristics, high-rate charging and discharging characteristics, and low-temperature characteristics can be improved; since the content of functional groups on the surface of the activated carbon is low, there can be provided a supercapacitor and a lithium ion capacitor, having improved high voltage and lifespan characteristics; and the time for preparing an active material can be significantly shortened and thus the material cost and the process cost can be remarkably reduced.

### CROSS REFERENCE(S) TO RELATED APPLICATIONS

This application claims the benefit under 35 U.S.C. Section 119 of Korean Patent Application Serial No. 10-2012-0146427, entitled “Activated Carbon, Method for Preparing the Same, and Electrochemical Capacitor Including the Same” filed on Dec. 14, 2012, which is hereby incorporated by reference in its entirety into this application.

### BACKGROUND OF THE INVENTION

1. Technical Field

The present invention relates to an activated carbon, a method for preparing the same, and an electrochemical capacitor including the same.

2. Description of the Related Art

Recently, as fossil fuel prices are rising rapidly due to the depletion of fossil energy and exhaust gas regulations for prevention of environmental pollution has gradually strengthened, developer companies of land transport vehicles including cars have focused on the development of eco-friendly transportation vehicles having high fuel efficiency while using alternative energy.

Hybrid vehicles and trains that use two or more power sources are evaluated as vehicles that can secure generic technology for a short time and realistically respond to world various regulations. Therefore, vehicle developer companies are actively developing hybrid power sources that raise engine efficiency by adding an electric motor and an electrical energy storage device to the existing internal combustion engine and diesel engine and improve vehicle fuel efficiency and reduce exhaust gas emission by using regenerative braking energy.

As the energy storage device, a secondary battery such as Ni-MH or Li based battery is being considered. However, this secondary battery needs to be frequently replaced and precisely checked due to a short lifespan, low output, and deterioration in low-temperature characteristics, which may cause additional maintenance costs. Moreover, the secondary battery always has the risk of explosion and fire in spite of an over-protection circuit and various controllers for securing stability in an emergency situation.

Whereas, an electrochemical capacitor generally called a supercapacitor or an ultracapacitor is a system that stores energy by using an electric double layer generated by physically absorbing or desorbing ions onto or from an interface between a surface of a material having a large specific surface area and an electrolyte. The electrochemical capacitor are excellent in lifespan, charging and discharging efficiency, a wide range of operation temperature, and reliability, and thus is being emphasized as a technology for supplementing weakness of the secondary battery. The electrochemical capacitor does not require a complicated protection circuit such as a Li-based secondary battery, and may be used by connecting only simple voltage balancing circuits in parallel with each other. In addition, since the state of charge is directly proportional to voltage, residual capacitance is easily measured and convenient control is possible. An electric double layer capacitor, which is a kind of the electrochemical capacitor, normally operates even though polarity is changed, and has no risk of explosion. Therefore, the electrochemical capacitor is being highlighted as a more suitable energy storage device used as a vehicle engine auxiliary power source requesting frequent high output and having a lot of regenerative braking.

However, most electrochemical capacitors need to be mounted in a limited space that is closed inside a vehicle, and need to secure durability suitable for a severe use environment. Particularly, in order to supply several tens to several hundreds of kilowatts of high output, several to several hundreds of single cells are connected in series or in series and in parallel to constitute a high-voltage capacitor module, and the module needs to be weight-lightened so as to mount a vehicle thereon. For achieving this, is important to increase energy density of the cell by increasing specific capacitance of the single cell and raising the rated voltage to 2.8V or higher. In addition, in order to continuously supply high output of about 0.1 watt to 10 watts per Farad, a high-output electrode is needed. For this reason, it is important to develop, as an electrode active material, an activated carbon having pores with appropriate sizes so that ions in an electrolytic liquid are easily movable into the pores of the activated carbon.

FIG. 1 is a process view showing a method for preparing activated carbon according to the related art.

Referring to this, char is prepared by applying heat to a raw material after drying, to prepare char; pulverizing the char; applying heat to the char to be activated while supplying an oxidative reactive gas; performing a reduction treatment (heat treatment) in hydrogen or inert ambience; performing washing to remove metal impurities; and performing drying and pulverizing.

According to the related art as described above, the activated carbon was prepared by carbonizing various carbon materials by external heating such as a rotary kiln, a heating furnace, or the like, and then performing gas activation using a reductive gas or chemical activation using an aqueous alkaline solution. However, this technology for preparing an activated carbon causes an increase in specific surface area of the activated carbon due to carbonization and activation of a start material, and thus is not appropriate for an active material of an electrochemical capacitor, such as a supercapacitor or a lithium ion capacitor. The reason is that most activated carbon prepared in the related art has pores with pore sizes of 1 nm or smaller, which makes it difficult to implement capacitance, in consideration that a specific surface area and a pore volume of an activated carbon, which contribute to actual capacitance in an organic based electrolytic liquid, generally depend on the fraction of pores with pore sizes of 1 nm or greater.

Japanese Patent Laid-Open Publication No. 2006-151784 discloses a method for preparing an activated carbon by impregnating a phenol fiber with an aqueous alkaline solution as an activator, and then performing argon microwave plasma heating. However, this method has problems in that strong alkali having a high risk of fire due to strong reactivity is used; process and maintenance costs are high due to collection of the entire quantity of alkali after the reaction and corrosion of reaction containers and peripheral equipment; and as the specific surface area of effective pores contributing to capacitance increases, the overall specific area, also, increases, resulting in lowering the electrode filling degree, thereby reducing the capacitance per cell volume.

As described above, the related art has a limit in preparing an activated carbon having pores with a uniform size, which can contribute to factual capacitance.

### RELATED ART DOCUMENT

### Patent Document

(Patent Document 1) Japanese Patent Laid-Open Publication No. 2006-151784

### SUMMARY OF THE INVENTION

An object of the present invention is to provide an activated carbon having less surface functional groups while having effectively uniform sized fine pores, by activating a surface of a carbon material with a catalyst, using a surfactant, so as to increase the microwave absorption rate, and then performing microwave heating, and a method for preparing the activated carbon.

Another object of the present invention is to provide an electrochemical capacitor employing the activated carbon as an electrode active material.

According to an exemplary embodiment of the present invention, there is provided an activated carbon in which pores with pore sizes of 0.3.5 nm account for 80% or higher based on an overall pore volume.

The activated carbon may have a specific surface area of 1000˜2200 m²/g and an overall pore volume of 0.7˜1.2 cc/g.

Here, a content of functional groups in the activated carbon may be 0.100 meq/g or less.

Here, a content of impurity in the activated carbon may be 300 ppm or less.

The impurity may be at least one metal or oxide selected from to group consisting of Fe, Cu, K, Sn, Ru, Rh, Pd, Ta, Os, Mo, Mn, Ni, Co, Ir, W, V, SiC, WC, TiC, NaCl, ferrite, TiO₂, SiO₂, and Al₂O₃.

Here, fine pores with pore sizes of 1.2˜2.5 nm may account for 30% or higher based on the overall pore volume.

According to another exemplary embodiment of the present invention, there is provided an electrochemical capacitor including the activated carbon described above as an electrode active material for an electrode.

The electrode may be a negative electrode or a positive electrode.

The electrochemical capacitor may be a supercapacitor or a lithium ion capacitor.

According to still another exemplary embodiment of the present invention, there is provided a method for preparing an activated carbon, the method including: carbonizing a carbon material to a char and pulverizing the char to 10 μm or smaller; impregnating the char with a surfactant and adsorbing a catalyst on a surface of the char, to prepare a char slurry; drying the char slurry such that a moisture content in the char slurry becomes 30˜50%; performing microwave irradiation on the dried char to activate the char; and removing the catalyst.

The char may have a C/H mole ratio of 3 or higher and absorbs microwaves of 25 watts or higher per weight.

The surfactant may be contained in a content of 0.1˜50 wt % based on a weight of the char.

The surfactant may be at least one negative ion surfactant selected from the group consisting of sodium linear alkyl benzene sulfonate, sodium dodecyl benzene sulfonate, methyl propyne sulfonate, alkyl benzene sulfonate, alkyl amide sulfonate, olefin sulfonate, propyl naphthalene sulfonate, lignin sulfonate, melamine sulfonate, sodium salt sulfonate, and lithium salt sulfonate.

The catalyst may be contained in a content of 0.1˜100 wt % based on a weight of the char.

The catalyst may be at least one metal or oxide selected from the group consisting of Fe, Cu, K, Sn, Ru, Rh, Pd, Ta, Os, Mo, Mn, Ni, Co, Ir, W, V, SiC, WC, TiC, NaCl, ferrite, TiO₂, SiO₂, and Al₂O₃.

The microwave irradiation may be performed under conditions of a frequency of 2.45 GHz±50 MHz and an output range of 0.3˜5 kW for 2˜60 minutes.

The activating of the char may be performed under a supply of at least one selected from steam and CO₂ gas.

### BRIEF DESCRIPTION OF THE DRAWINGS

FIG. 1 is a process view showing a method for preparing an activated carbon according to the related art;

FIG. 2 is a process view showing a method for preparing an activated carbon according to the present invention;

FIG. 3 is a graph showing the microwave absorption power depending on the C/H mole ratio;

FIG. 4 is a schematic diagram showing an inside of a pore of an activated carbon activated by the related art; and

FIG. 5 is a schematic diagram showing an inside of a pore of an activated carbon activated by the present invention.

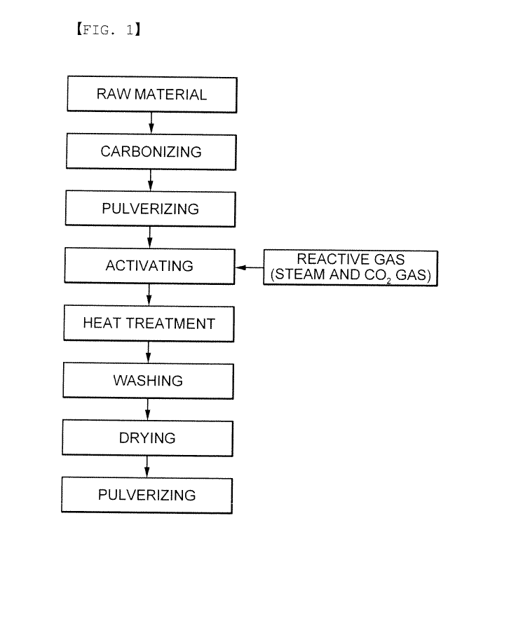

### DESCRIPTION OF THE PREFERRED EMBODIMENTS

Hereinafter, the present invention will be described in more detail.

Terms used in the present specification are for explaining the embodiments rather than limiting the present invention. As used herein, unless explicitly described to the contrary, a singular form includes a plural form in the present specification. Also, used herein, the word “comprise” and/or “comprising” will be understood to imply the inclusion of stated constituents, steps, operations and/or elements but not the exclusion of any other constituents, steps, operations and/or elements.

The present invention is directed to a high-grade activated carbon having less surface functional groups while having effectively uniform sized fine pores, by activating a surface of a carbon material so as to increase the absorption rate of microwave, and then performing microwave heating, a method for preparing the activated carbon, and an electrochemical capacitor employing the activated carbon.

In the activated carbon according to the present invention, pores with pore sizes of 0.3˜5 nm account for 80% or higher based on the overall pore volume, and more preferably, pores with pore sizes of 1.2˜2.5 nm account for 30% or higher based on the overall pore volumes.

The activated carbon according to the present invention is used as an electrode active material of an electrochemical capacitor. For achieving this, the activated carbon needs to have pores with appropriate pore sizes so that ions in an organic electrolytic liquid are easily movable into pores inside the activated carbon.

The reason is that the actual capacitance in the general organic based electrolytic liquid depends on the fraction of pores with pore sizes of 1 nm or greater. This results from the fact that pores with pore sizes of 1 nm or smaller, which makes it difficult to implement capacitance, account for most of the general activated carbon prepared by the related art.

However, since in the activated carbon according to the present invention, pores with pore sizes of 0.3˜5 nm account for 80% or higher based on the overall pore volume, and preferably pores with pore sizes of 1.2˜2.5 nm account for 30% or higher and more preferably 35% or higher based on the overall pore volumes, the ions in the organic electrolytic liquid are easily movable, and thus contribute to implementation of high capacitance, resulting in improving high-rate discharge characteristics, high-rate charging and discharging characteristics, and low-temperature characteristics.

In addition, the activated carbon according to the present invention has a specific surface area of 1000˜2200 m²/g and a pore volume of 0.7˜1.2 cc/g. In the above ranges of the specific surface area and the pore volume, the activated carbon has apparent density of 0.4 g/cc or higher, and thus the filling density of the active material increases and the content of the active material per electrode volume increases, so that electrode specific capacity per volume can be increased and high-capacitance characteristics can be obtained.

In addition, in the activated carbon according to the present invention, the functional group content on a surface thereof is 0.100 meq/g or less, and preferably within 0.6 meq/g. As such, since the functional group content on the surface of the activated carbon according to the present invention is low, a supercapacitor having improved high-voltage characteristics of 2.8V or higher and lifespan characteristics can be manufactured, and since the activated carbon according to the present invention as an electrode material of a lithium ion capacitor improves high-voltage characteristics, a lithium ion capacitor having durability to high voltage can be manufactured.

In addition, the activated carbon according to the present invention is characterized by having an impurity content of 300 ppm or lower. Since the impurity content in the activated carbon is low, high-purity activated carbon can be prepared, and this activated carbon may be used as an electrode material, to thereby improve capacitance. The impurity may be at least one metal or oxide selected from the group consisting of Fe, Cu, K, Sn, Ru, Rh, Pd, Ta, Os, Mo, Mn, Ni, Co, Ir, W, V, SiC, WC, TiC, NaCl, ferrite, TiO₂, SiO₂, and Al₂O₃.

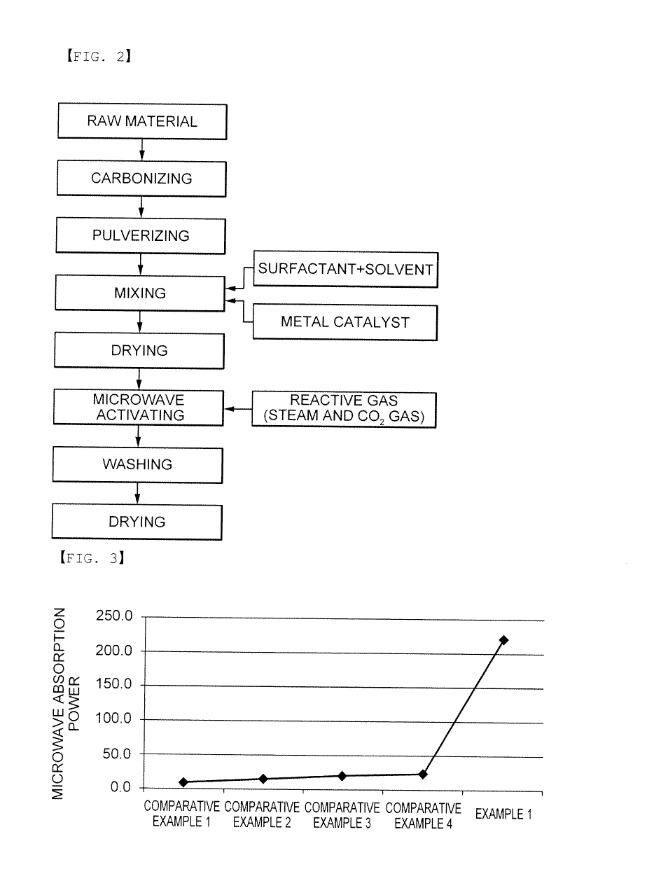

The activated carbon according to the present invention may be prepared with reference to a process view shown in FIG. 2.

Referring to the drawing, a method for preparing an activated carbon, the method may include: carbonizing a carbon material to a char and pulverizing the char to 10 μm or smaller; impregnating the char with a surfactant and adsorbing a catalyst on a surface of the char, to prepare a char slurry; drying the char slurry such that a moisture content in the char slurry becomes 30˜50%; performing microwave irradiation on the dried char to activate the char; and removing the catalyst.

As a first step, a raw material for preparing an activated carbon is carbonized into a char, and the char is pulverized to 10 μm or smaller.

The raw material for preparing an activated carbon is selected from coconut based shells, apricot seeds, rice hulls, sawdust, cotton, sugarcane, and other plants, but is not particularly limited. The raw material is carbonized by applying heat at a temperature of 300˜800° C. for 2˜4 hours.

The prepared char is pulverized to about 10 μm or smaller. The reason is that a surfactant and a catalyst uniformly permeate into a surface and pores of the char, to thereby activate the surface of the char, and, at the time of microwave irradiation during a fourth step, the char itself is promptly and uniformly heated to a high temperature, to thereby increase the frequency of collision of steam molecules on the surface of the char and in the pores of the char, resulting in generating fine pores and medium pores. Also, this is for preventing problems in that pulverization is difficult and yield is lowered, which are caused by a decrease in density of activated carbon after activation and fly of particles, occurring when the activated carbon is pulverized to a sub-micro level requested at the time of forming an electrode.

In addition, the carbonizing may be preferably performed to such a level that aliphatic hydrocarbon of the raw material is carbonized to be converted into multiple bond hydrocarbon and aromatic hydrocarbon so that the char has a C/H mole ratio, representing a carbonizing degree, of 3 or greater, and absorbs microwaves of 25 watts or higher per weight.

The reason is that it is preferable to use a carbon material having a high carbonizing degree in order to supply energy necessary for a chemical reaction through absorption of microwave. If the C/H mole ratio, representing the carbonizing degree, is 3 or higher, more numbers of multiple bond aliphatic and aromatic materials having short molecule chain length are present, and thus molecule rotation is easy, resulting in absorbing a lot of microwaves.

In addition, it is preferable to perform carbonizing to such a level that the char absorbs 25 watts or higher of microwaves per weight, in order to supply energy necessary for the chemical reaction.

As a next step, the char is impregnated with a surfactant, and a catalyst is adsorbed on a surface of the char, to thereby make the char a slurry state.

In the present invention, activation reaction sites are increased by adsorbing the surfactant on the surface and pores of the char and subsequently adsorbing a catalyst having a high microwave absorption rate thereto.

In this case, when, after that, steam, an oxidative gas, is inputted while microwaves are irradiated, heat generation of the char itself allows the inside and surface of the char to be uniformly and promptly heated, thereby activating the catalyst on the surface and in the pores of the char. At the same time, the surfactant functions to lower surface tension of the steam, thereby allowing adsorption of a large amount of steam. Therefore, steam molecules, together with the catalyst, rotate and vibrate according to the microwave frequency, and collide with the surface and pore wall surfaces of the char, to thereby generate new pores or enlarge fine pores, and through this procedure, a high-purity activated carbon, of which fine pores have a uniform size and oxygen functional groups distributed on the surface of the char are removed, can be prepared.

In addition, a surfactant of 0.1˜50 wt % based on a weight ratio of the char is dissolved in a deionized water, in which the char is then dipped, and subsequently a catalyst of 0.01˜100 wt % based on a weight of the char is added thereto, to thereby prepare a slurry state char. Here, in order to remove air generated while the surfactant and the catalyst permeate into the pores of the char at the time of impregnation and thus improve wettability to solvent, room pressure or low-vacuum ambience is kept, and in order to achieve uniform distribution and adsorption of the surfactant and the catalyst on the surface of the char and in the pores of the char, a stirrer may be employed.

As the surfactant, a negative ion surfactant where a lipophilic part is ion-dissociated into negative ions in an aqueous solution may be mainly used, but is not limited thereto. Specific examples of this surfactant may be at least one negative ion surfactant selected from the group consisting of sodium linear alkyl benzene sulfonate, sodium dodecyl benzene sulfonate, methyl propyne sulfonate, alkyl benzene sulfonate, alkyl amide sulfonate, olefin sulfonate, propyl naphthalene sulfonate, lignin sulfonate, melamine sulfonate, sodium salt sulfonate, and lithium salt sulfonate.

In addition, the catalyst has a great dielectric constant and a great dielectric loss factor and thus easily absorbs microwaves to be well heated, or the catalyst is a polarizable material and thus catalyst molecules vibrate correspondingly to the microwave frequency, to generate heat due to frictional force between molecules, whereby the catalyst serves to activate the surface of the char to promote reactions.

Specific examples of the catalyst may be at least one metal catalyst or oxide catalyst selected from the group consisting of Fe, Cu, K, Sn, Ru, Rh, Pd, Ta, Os, Mo, Mn, Ni, Co, Ir, W, V, SiC, WC, TiC, NaCl, ferrite, TiO₂, SiO₂, and Al₂O₃.

As a next stage, the char slurry is dried so as to have a moisture content of 30˜50% therein, to thereby prepare a powder where the surface of the char is activated. Here, the char slurry is not completely dried, but the char slurry is preferably dried such that the solvent permeating into the pores of the char remains at a content of 30˜50%.

The reason is that, at the time of microwave irradiation, water molecules inside the pore of the char are transformed into steam due to generated heat of the char itself, and the steam molecules and the catalyst inside the pore vibrate a number of times corresponding to the microwave frequency, to generate friction heat, and thus the pores of the char are entirely heated to a high temperature, so that the number of molecules colliding with a wall of the pore of the char is increased, which may be utilized as an initiator for enlarging a fine pore.

As a next step, the dried char is activated by irradiating microwave thereto. The activation may be performed in oxidative ambience, and here, as an oxidative gas, steam may be used alone or a mixed reactive gas of steam and CO₂ gas may be used.

The microwaves may be irradiated at a frequency range of 300 MHz˜30 GHz, and preferably 2.45 GHz±50 MHz, an ISM use band, and an output range of 0.3˜5 kW, for 2˜60 minutes. A microwave reaction container may be formed of a quartz material, a nickel surface-coated material, or a stainless steel material.

In addition, in the removing of the catalyst, washing is performed by using an acidic solution or an alkaline solution capable of dissolving the catalyst and then water washing is performed until the pH value is 6˜8, corresponding to a neutral pH value.

Lastly, the resultant material is dried to obtain a final powder. The drying may be performed by various methods such as hot-air drying, microwave drying, far-infrared drying, and the like.

The thus prepared activated carbon of the present invention may be used as an electrode material for an electrode of an electrochemical capacitor.

The electrode may be used for a negative electrode and a positive electrode.

The electrochemical capacitor may be a supercapacitor or a lithium ion capacitor.

The electrochemical capacitor using the activated carbon according to the present invention as an electrode active material has improved high-rate discharge characteristics, high-rate charging and discharging characteristics, and low-temperature characteristics, since the activated carbon has pores with a uniform pore size. In addition, since the content of functional groups on the surface of the activated carbon is low, there can be provided a supercapacitor and a lithium ion capacitor, having improved high voltage and lifespan characteristics.

Hereinafter, examples of the present invention will be described in detail. The following examples merely illustrate the present invention, but the scope of the present invention should not be construed to be limited by these examples. Further, the following examples are illustrated by using specific compounds, but it is apparent to those skilled in the art that equivalents thereof are used to obtain equal or similar levels of effects.

### Example 1

### Preparation of Char

Coconut shells as a raw material filled a quartz tube reactor with an inner diameter of 20 mm to a height of 5 cm. The temperature was raised to 600° C. at a rate of 30° C./min in nitrogen ambience of 2 L/min, and then carbonizing was performed at that temperature for 30 minutes. As the analysis results of the raw material, the C/H mole ratio was 3.5.

### Comparative Examples 1 to 4

### Preparation of Char

Char was prepared by the same method as Example 1 except that only the carbonizing temperature was varied to 0° C., 300° C., 400° C., and 500° C. for the respective comparative examples. As the analysis results of the raw material, the C/H mole ratios at the carbonizing temperatures were 0.63, 1.10, 1.57, and 2.71, respectively.

### Experimental Example 1

### Microwave Absorption Power Depending on C/H Mole Ratio

In order to confirm capability of char to absorb microwaves during an activating process, the carbonizing temperature was varied to prepare chars, of which C/H mole ratios, representing the carbonizing degree, are different. Thus, chars according to the example and the comparative examples were prepared.

The microwave absorption power depending on the C/H mole ratio in each of the chars prepared by Example 1 and Comparative Examples 1 to 4 was measured, and the results were shown in Table 1 below and FIG. 3 below. Elements of the char, C, H, and N were measured based on the dried sample by using an elemental analyzer, and the C/H mole ratio was calculated from the element analysis results.

TABLE 1

| | | Microwave |
|---|---|---|
| Classification | C/H Mole Ratio | Absorption Power (W/g)¹ |
| Comparative Example 1 | 0.63 | 9.3 |
| Comparative Example 2 | 1.10 | 14.9 |
| Comparative Example 3 | 1.57 | 20.3 |
| Comparative Example 4 | 2.71 | 23.4 |
| Example 1 | 3.50 | 221.5 |

¹Microwave Absorption Power per Sample 1 g

The results of Table 1 above and FIG. 3 below showed that the microwave absorption power of the char having a C/H mole ratio of 3.0 or higher (Example 1) was higher than that of the chars having a C/H more ratio of below 3.0 (Comparative Examples 1 to 4). It may be seen from these results that the microwave absorption capability was different depending on the C/H mole ratio of the char, and it may be confirmed that the C/H mole ratio of the char needs to be 3.0 or higher in order to obtain a desired level of microwave absorption power (25 watts or higher per weight).

### Example 2

### Preparation of Activated Carbon

Activated carbon was prepared following the process shown in FIG. 2. First, char having a C/H mole ratio of 3.5 was prepared by Example 1, and then pulverized to 10 μm.

Then, the pulverized char was impregnated with a solution where a sodium based sulfonate surfactant of 5 wt % based on the weight ratio of the char was dissolved in deionized water.

In addition, a SiC catalyst of 25 wt % based on the weight ratio of the char was added to the deionized water to be adsorbed on a surface of the char and pores thereof, to thereby prepare a char slurry. Here, stirring was conducted by using the T. K. Homomixer high-speed stirrer at 2000 rpm for 30 minutes.

Then, the char was dried such that the moisture content in the char slurry became 30%, to thereby prepare a char powder. The dried char powder was activated by applying microwaves thereto at a frequency of 2.45 GHz±50 MHz and an output range of 0.6 kW for 5 minutes while supplying steam thereto.

The catalyst remaining in the powder was removed by using an aqueous 1N HCl solution, and water washing was conducted until a neutral pH value was obtained. The water-washed powder was hot-air-dried, and then particle-pulverized, to thereby prepare a final activated carbon.

### Examples 3 to 4

Each activated carbon was prepared by the same method as Example 2 except that the microwave irradiating time was varied to 15 minutes and 30 minutes, respectively.

### Comparative Examples 5 to 6

Commercialized activated carbon prepared by an existing steam activation method was used as Comparative Example 5 and commercialized activated carbon prepared by a chemical activation method was used as Comparative Example 6.

### Experimental Example 2

### Confirmation on Inner Structure of Pore of Activated Carbon

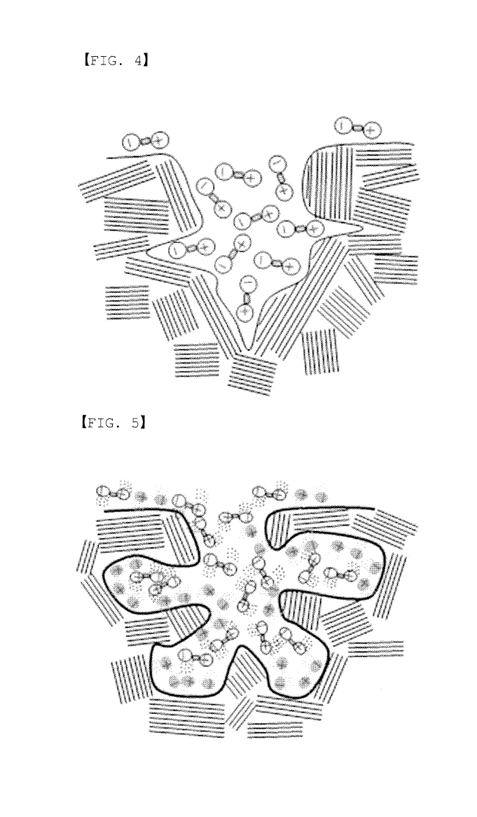

FIGS. 4 and 5 are schematic diagrams showing inner structures of activated carbons prepared according to Comparative Examples 5 and 4.

The activated carbon according to Comparative Example 5, activated by the related art (FIG. 4) has a pore with an inner structure, which is wide at an entrance portion thereof and becomes narrower toward an inside thereof. Whereas, the activated carbon according to Example 4, prepared by the method of the present invention (FIG. 5) has a pore of which an entrance portion and an inside have similar diameters since water molecules and catalyst in the pore vibrate due to microwaves, which break an inner wall of the pore.

### Experimental Example 3

### Confirmation on Physical Properties of Activated Carbon

The specific surface area and pore characteristics of the activated carbon prepared according to Examples 2 to 4 and Comparative Examples 5 and 6 were measured by using an isotherm adsorption apparatus of the BELSORP-max by BEL Japan Company. The functional group on the surface of the activated carbon was measured by Boehm method. The impurity content was measured by using an X-ray fluorescence spectrometer (XRF). The particle size was measured by using a particle size analyzer. The results were shown in Table 2 below.

TABLE 2

| | | | | Volume | | | | |
|---|---|---|---|---|---|---|---|---|
| | | | | of Pores | Volume of | | | |
| | Specific | Overall | Average | with | Pores with | Content of | Content | |
| | Surface | Pore | Pore | Sizes of | Sizes of | Functional | of | Particle |
| | Area | Volume | Size | 0.3~5 nm | 1.2~2.5 nm | Groups | Impurity | Size |
| | (m²/g) | (cc/g) | (nm) | (cc/g) | (cc/g) | (meq/g) | (ppm) | (μm) |
| Example 2 | 1116 | 0.7623 | 1.77 | 0.7470 | 0.4210 | 0.098 | 124 | 7.0 |
| Example 3 | 1358 | 1.0915 | 1.82 | 1.0609 | 0.4500 | 0.096 | 127 | 7.0 |
| Example 4 | 1584 | 1.2253 | 1.86 | 1.1640 | 0.4800 | 0.090 | 135 | 7.0 |
| Comparative | 1560 | 1.1814 | 1.91 | 1.0904 | 0.4364 | 0.113 | 365 | 6.0 |
| Example 5 | | | | | | | | |
| Comparative | 2290 | 1.5279 | 1.74 | 1.5269 | 0.5923 | 0.480 | 309 | 9.1 |
| Example 6 | | | | | | | | |

As shown in the results of Table 2 above, it was observed that Example 4 obtained by performing microwave heat treatment for 30 minutes had a specific surface area similar to that of Comparative Example 1, but a very high total pore volume with 1.2253 c/gm and the lowest content of functional groups with about 0.09 meq/g.

In addition, it may be seen that, as for the activated carbon of Example 4 prepared by the method of the present invention, the fraction of fine pores with pore sizes of 1.2˜2.5 nm in the total pore volume is higher and the content of functional groups and the content of impurity are lower, as compared with the activated carbon of Comparative Examples 5 and 6, prepared by the related method, and thus a high-purity powder can be prepared.

### Examples 5 to 7 Manufacture of Supercapacitor Cell

90 wt % of the activated carbon powder prepared from each of Examples 2 to 4, 5 wt % of a carbon black based conducting agent, and 5 wt % of a butadiene based polymer and carboxyl methyl cellulose as a binder were mixed with each other, and then deionized water was added thereto, to prepare a slurry. The slurry was coated on an aluminum current collector to a thickness of 200 μm and then dried, to form an electrode.

The dried electrode was cut to prepare a positive electrode and a negative electrode, and a pulp based separator was inserted between the positive electrode and the negative electrode, which was then wound in a jelly roll type. This was inserted into an exterior cladding having a diameter of 18 mm and a height of 40 mm, and then finally impregnated with an acetonitrile (AN) electrolytic liquid where 1M tetraethyl ammonium tetrafluoroborate (TEABF4) was dissolved, thereby manufacturing a supercapacitor cell.

### Comparative Examples 7 to 8

Supercapacitor cells were manufactured by the same method as Examples 5 to 7 except that the activated carbon powders prepared from Comparative Examples 5 and 6 were used.

### Experimental Example 4

### Evaluation on Performance of Super Capacitor Cell

In order to confirm performances of the cells manufactured from Comparative Examples 7 and 8 and Examples 5 to 7, initial characteristics were measured at 2.85V and room temperature and high-temperature lifespan evaluation was conducted under conditions of 2.85V and 85° C. In order to measure the initial characteristics, each cell was charged to 2.85 V and discharged at 0.5 A to obtain a discharge capacitance, and also, cell resistance was measured from IR-drop at the time of discharging. In addition, for durability evaluation, each cell was maintained at 2.85V and 85° C. for 42 hours, and then maintained at room temperature for 12 hours, and then capacitance reduction and resistance increase of the cell and cell height variance were respectively measured, and the results were tabulated in Table 3 below.

TABLE 3

| | | | | | Cell lifespan Characteristics | | |
|---|---|---|---|---|---|---|---|
| | Time for | Electrode | Cell Initial | | | | Cell |
| | Microwave | Specific | Characteristics | | Capacitance | Resistance | Height |
| | Treatment | Capacitance | Capacitance | Resistance | Reduction | Increase | Increase |
| | (min) | (F/cc) | (F) | (mΩ) | (%) | (%) | (%) |
| Example 5 | 5 | 13.9 | 40.1 | 17.0 | 7.2 | 25.4 | 1.6 |
| Example 6 | 15 | 14.6 | 42.1 | 13.4 | 7.6 | 30.2 | 1.7 |
| Example 7 | 30 | 15.7 | 45.3 | 9.2 | 8.2 | 36.3 | 1.9 |
| Comparative | — | 14.0 | 40.4 | 10.5 | 12.2 | 59.4 | 2.1 |
| Example 7 | | | | | | | |
| Comparative | — | 18.2 | 53.0 | 9.7 | 17.5 | 44.7 | 3.1 |
| Example 8 | | | | | | | |

As shown in Table 3 above, Example 7 obtained by performing microwave heat treatment for 30 minutes had an electrode specific capacitance of 15.7 F/cc and resistance of 9.2 mΩ, which exhibited excellent initial characteristics, as compared with Comparative Example 7.

In addition, it may be confirmed that the supercapacitor cells of Examples 5 to 7 containing, as an electrode active material, the activated carbon prepared by the present invention had remarkably improved capacitance reduction and resistance increase even after high-temperature lifespan evaluation, as compared with the supercapacitor cell of Comparative Examples 7 and 8 containing, as an electrode active material, the activated carbon prepared according to the related art.

As set forth above, according to the present invention, the yield of activated carbon powder can be increased by pulverizing the char to a submicron level size, activating the surface thereof through the surfactant and the catalyst, and then performing microwave heating. Further, the activated carbon powder is entirely and uniformly activated, so that specific capacitance can be improved. The process time for preparing the active material is shortened, so that the material cost and the process cost can be remarkably reduced.

Further, in the case where the activated carbon of the present invention is used as an electrode active material of an electrochemical capacitor, high-rate discharging characteristics, high-speed charging and discharging characteristics, and low-temperature characteristics can be improved since the activated carbon has such an appropriate pore size that the ions in the electrolytic liquid are easily movable into pores of the activated carbon.

Further, the content of functional groups on the surface of the activated carbon is low, so that a supercapacitor having high voltage characteristics of 2.8V or higher and lifespan characteristics can be manufactured. In addition, the activated carbon of the present invention is used as an active material of a lithium ion capacitor to improve high voltage characteristics, so that a lithium ion capacitor having high-voltage durability can be manufactured.

What is claimed is:

1. An activated carbon in which pores with pore sizes of 0.3˜5 nm account for 80% or higher based on an overall pore volume.

2. The activated carbon according to claim 1, wherein the activated carbon has a specific surface area of 1000˜2200 m²/g and an overall pore volume of 0.7˜1.2 cc/g.

3. The activated carbon according to claim 1, wherein a content of functional groups in the activated carbon is 0.100 meq/g or less.

4. The activated carbon according to claim 1, wherein a content of impurity in the activated carbon is 300 ppm or less.

5. The activated carbon according to claim 4, wherein the impurity is at least one metal or oxide selected from the group consisting of Fe, Cu, K, Sn, Ru, Rh, Pd, Ta, Os, Mo, Mn, Ni, Co, Ir, W, V, SiC, WC, TiC, NaCl, ferrite, TiO₂, SiO₂, and Al₂O₃.

6. The activated carbon according to claim 1, wherein fine pores with pore sizes of 1.2˜2.5 nm account for 30% or higher based on the overall pore volume.

7. An electrochemical capacitor comprising the activated carbon according to claim 1 as an electrode active material for an electrode.

8. The electrochemical capacitor according to claim 7, wherein the electrode is a negative electrode or a positive electrode.

9. The electrochemical capacitor according to claim 7, wherein the electrochemical capacitor is a supercapacitor or a lithium ion capacitor.

10. A method for preparing an activated carbon, the method comprising:
carbonizing a carbon material to a char(-> char) and pulverizing the char to 10 μm or smaller;
impregnating the char with a surfactant and adsorbing a catalyst on a surface of the char, to prepare a char slurry;
drying the char slurry such that a moisture content in the char slurry becomes 30˜50%;
performing microwave irradiation on the dried char to activate the char; and
removing the catalyst.

11. The method according to claim 10, wherein the char has a C/H mole ratio of 3 or higher and absorbs microwaves of 25 watts or higher per weight.

12. The method according to claim 10, wherein the surfactant is contained in a content of 0.1˜50 wt % based on a weight of the char.

13. The method according to claim 10, wherein the surfactant is at least one negative ion surfactant selected from the group consisting of sodium linear alkyl benzene sulfonate, sodium dodecyl benzene sulfonate, methyl propyne sulfonate, alkyl benzene sulfonate, alkyl amide sulfonate, olefin sulfonate, propyl naphthalene sulfonate, lignin sulfonate, melamine sulfonate, sodium salt sulfonate, and lithium salt sulfonate.

14. The method according to claim 10, wherein the catalyst is contained in a content of 0.1˜100 wt % based on a weight of the char.

15. The method according to claim 10, wherein the catalyst is at least one metal or oxide selected from the group consisting of Fe, Cu, K, Sn, Ru, Rh, Pd, Ta, Os, Mo, Mn, Ni, Co, Ir, W, V, SiC, WC, TiC, NaCl, ferrite, TiO₂, SiO₂, and Al₂O₃.

16. The method according to claim 10, wherein the microwave irradiation is performed under conditions of a frequency of 2.45 GHz±50 MHz and an output range of 0.3˜5 kW for 2˜60 minutes.

17. The method according to claim 10, wherein the activating of the char is performed under a supply of at least one selected from steam and CO₂ gas.
